(19) United States
(12) Patent Application Publication
(10) Pub. No.: US 2012/0056555 A1
(43) Pub. Date: Mar. 8, 2012

(54) LIGHT EMITTING DIODE ILLUMINATOR AND ILLUMINATION CONTROL INTERFACE OF THE LIGHT EMITTING DIODE ILLUMINATOR

(76) Inventors: Wan-Yu Hsieh, TAICHUNG CITY (TW); Chi-Hsiang Wang, TAICHUNG CITY (TW)

(21) Appl. No.: 12/877,278

(22) Filed: Sep. 8, 2010

(51) Int. Cl. H05B 37/02

(52) U.S. Cl. 315/294

(57) ABSTRACT

A light emitting diode illuminator includes at least one light emitting diode, a power supply, an illumination control interface and a controller. The power supply is electrically connected to the at least one light emitting diode so as to provide a current to the at least one light emitting diode. The illumination control interface is configured to sense a touch time from a user so as to generate a control signal. The controller is electrically connected to the illumination control interface and the power supply so as to generate a modulation signal according to the control signal. The power supply adjusts strength of the current according to the modulation signal so that the at least one light emitting diode generates a corresponding illumination according to the strength of the current.

### FIELD OF THE INVENTION

The present invention relates to a light emitting diode illuminator and the illumination control interface of the light emitting diode illuminator, wherein the illumination is adjusted according to the touch time from the users.

### BACKGROUND OF THE INVENTION

A conventional illuminator generally uses a light bulb or light tube. However, the conventional light bulbs and light tubes have low efficiency and consume significant power. Besides, the switch for the conventional light bulbs and light tubes is mechanical switch which requires the users to apply a force to the switch so as to activate the conventional light bulbs and light tubes. Some of the mechanical switches can adjust the illumination of the conventional light bulbs and light tubes according the users' need, but these switches are easily worn out after being operated for a period of time. For the past few years, light emitting diodes (LEDs) are developed and used widely in many areas because the LEDs are compact and have higher efficiency.

A switch that can be easily operated and can adjust the illumination of the LEDs are needed without using the mechanical switches.

The present invention intends to provide a light emitting diode illuminator and the illumination control interface of the light emitting diode illuminator, wherein the illumination can be adjusted by touching the illuminator.

### SUMMARY OF THE INVENTION

The present invention relates to a light emitting diode illuminator and comprises at least one light emitting diode, a power supply, an illumination control interface and a controller, wherein the power supply is electrically connected to the at least one light emitting diode so as to provide electric current to the at least one light emitting diode. The illumination control interface senses the touch time from a user so as to generate a control signal. The controller is electrically connected to the power supply and the illumination control interface so as to generate a modulation signal according to the control signal. The power supply adjusts the electric current according to the modulation signal and the at least one light emitting diode generates an illumination according to the electric current.

The light emitting diode illuminator is electrically connected to the illumination control interface which is able to sense the touch time from a user so as to generate a control signal. The light emitting diode illuminator comprises at least one light emitting diode, a power supply and a controller, wherein the power supply is electrically connected to the at least one light emitting diode so as to provide electric current to the at least one light emitting diode. The controller is electrically connected to the power supply and the illumination control interface so as to generate a modulation signal according to the control signal. The power supply adjusts the electric current according to the modulation signal and the at least one light emitting diode generating an illumination according to the electric current.

The illumination control interface is electrically connected to the light emitting diode illuminator, and comprises a touch sensor for sensing touch time from a user so as to generate a touch signal. A controller is electrically connected to the touch sensor and generates a control signal according to the touch signal. The light emitting diode illuminator generates an illumination according to the control signal.

The primary object of the present invention is to provide a light emitting diode illuminator whose illumination can be adjusted by touching the illumination control interface.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the light emitting diode illuminator of the present invention, and

FIG. 2 shows the light emitting diode illumination system of the present invention.

### DETAILED DESCRIPTION OF THE PREFERRED EMBODIMENT

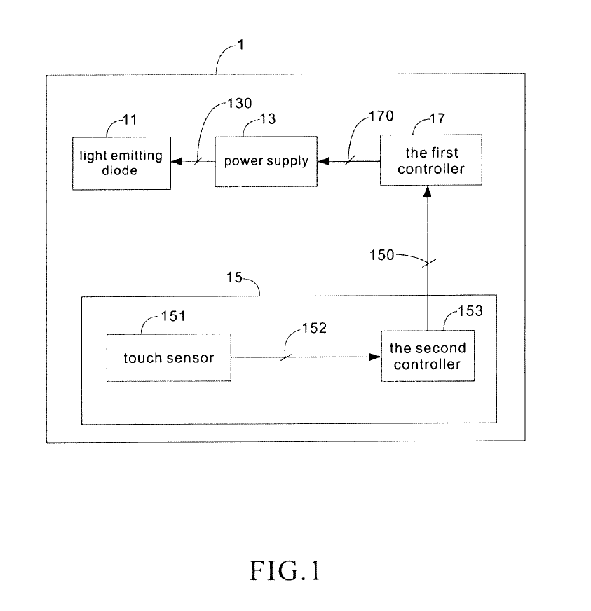

Referring to FIG. 1, the light emitting diode illuminator 1 of the present invention can be used in interior or exterior to provide illumination. The light emitting diode illuminator 1 comprises at least one light emitting diode 11, a power supply 13, an illumination control interface 15 and a first controller 17. The second controller 153 is electrically connected to the power supply 13 and the illumination control interface 15. The power supply 13 is electrically connected to the at least one light emitting diode 11 so as to provide electric current 130 to the at least one light emitting diode 11.

The illumination control interface 15 senses the touch time from a user so as to generate a control signal 150. The second controller 153 generates a modulation signal 170 to the power supply 13 according to the control signal 150. The power supply 13 adjusts the electric current 130 according to the modulation signal 170 and the at least one light emitting diode 11 illuminates correspondingly according to the electric current 130.

The illumination control interface 15 comprises a touch sensor 151 and a second controller 153. The second controller 153 is electrically connected to the touch sensor 151, the touch sensor 151. When the user wants to adjust the illumination, he or she touches the illumination control interface 15 which detects the touch time from the user and generates a touch signal 152. The second controller 153 generates the control signal 150 according to the touch signal 152. The first controller 17 generates the modulation signal 170 according to the control signal 150 to allow the power supply 13 to adjust the electric current 130.

It is noted that the control signal 150 is a pulse width modulation signal and the first controller 17 and the second controller 153 can be FPGA, DSP or any control chip in the market. In this embodiment, the touch sensor 151 is an electric capacitor touch sensor.

When the user continuously touches the illumination control interface 15 for five seconds, the touch sensor 151 generates a touch signal 152, and the second controller 153 generates the control signal 150 to the first controller 17 according to the touch signal 152. The first controller 17 generates the modulation signal 170 according to the control signal 150. The power supply 13 adjusts the electric current 130 according to the modulation signal 170 so that the at least one light emitting diode 11 generates a corresponding illumination according to the electric current 130.

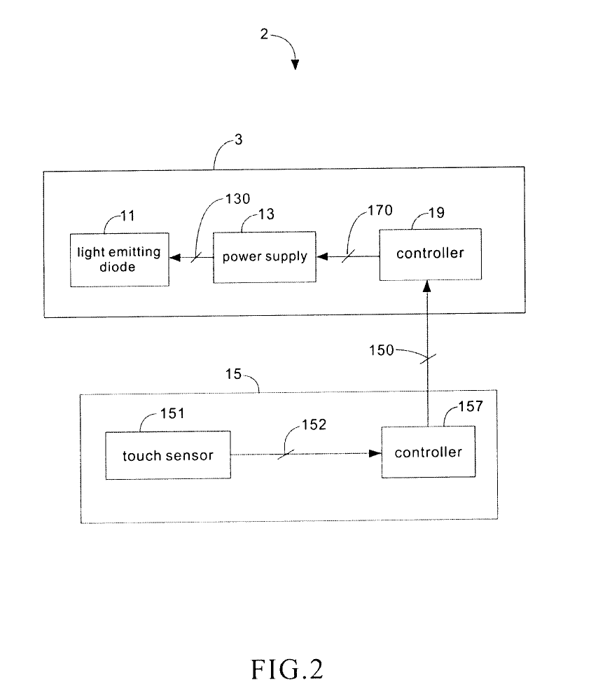

As shown in FIG. 2 which shows a light emitting diode illumination system 2 which comprises a light emitting diode illuminator 3 and an illumination control interface 15 which is electrically connected to the light emitting diode illuminator 3. The illumination control interface 15 comprises a touch sensor 151 and a controller 157. The light emitting diode illuminator 3 comprises at least one light emitting diode 11, a power supply 13 and a controller 19. The controller 17 of the illumination control interface 15 has the same functions as the second controller 153 in the first embodiment and the controller 19 of the light emitting diode illuminator 3 has the same functions as the first controller 17. The controller 157 of the illumination control interface 15 generates a control signal 150 according to the touch signal 152 of the touch sensor 151. The controller 19 generates a modulation signal 170 according to the control signal 150.

The light emitting diode illuminator 3 and the illumination control interface 15 can be used in different places such as the interior or exterior of a building, for example, the light emitting diode illuminator 3 is installed on a ceiling of an office and the illumination control interface 15 is installed on a wall so that the users can operate the illumination control interface 15 to adjust the illumination of the light emitting diode illuminator 3.

While we have shown and described the embodiment in accordance with the present invention, it should be clear to those skilled in the art that further embodiments may be made without departing from the scope of the present invention.

What is claimed is:

1. A light emitting diode illuminator comprising:
at least one light emitting diode;
a power supply electrically connected to the at least one light emitting diode so as to provide electric current to the at least one light emitting diode;
an illumination control interface for sensing touch time from a user so as to generate a control signal;
a first controller electrically connected to the power supply and the illumination control interface so as to generate a modulation signal according to the control signal, and
the power supply adjusting the electric current according to the modulation signal and the at least one light emitting diode generating an illumination according to the electric current.

2. The illuminator as claimed in claim 1, wherein the illumination control interface comprises a touch sensor and a second controller, the touch sensor is adapted to detect touch time from the user so as to generate a touch signal, the second controller is electrically connected to the touch sensor so as to generate the control signal according to the touch signal, a first controller generates the modulation signal according to the control signal.

3. The illuminator as claimed in claim 2, wherein the touch sensor is an electric capacitor touch sensor.

4. The illuminator as claimed in claim 2, wherein the control signal is a pulse width modulation signal and the first controller generates the modulation signal according to the control signal.

5. A light emitting diode illuminator electrically connected to an illumination control interface which is adapted to sense touch time from a user so as to generate a control signal, the light emitting diode illuminator comprising:
at least one light emitting diode;
a power supply electrically connected to the at least one light emitting diode so as to provide electric current to the at least one light emitting diode;
a controller electrically connected to the power supply and the illumination control interface so as to generate a modulation signal according to the control signal, and
the power supply adjusting the electric current according to the modulation signal and the at least one light emitting diode generating an illumination according to the electric current.

6. The illuminator as claimed in claim 5, wherein the control signal is a pulse width modulation signal and the controller generates the modulation signal according to the control signal.

7. An illumination control interface electrically connected to a light emitting diode illuminator, comprising:
a touch sensor for sensing touch time from a user so as to generate a touch signal, and
a controller electrically connected to the touch sensor and generating a control signal according to the touch signal, the light emitting diode illuminator generating an illumination according to the control signal.

8. The illuminator as claimed in claim 7, wherein the touch sensor is an electric capacitor touch sensor.

9. The illuminator as claimed in claim 7, wherein the control signal is a pulse width modulation signal and the light emitting diode illuminator generates illumination according to the modulation signal.
